(19) United States
(12) Patent Application Publication
(10) Pub. No.: US 2007/0127465 A1
(43) Pub. Date: Jun. 7, 2007

(54) Method for providing services from a server to a terminal over a mobile/wireless communication network, corresponding access node and terminal

(75) Inventor: Jean-Claude Faye, Gif sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/582,333

(22) Filed: Oct. 18, 2006

(30) Foreign Application Priority Data
Nov. 18, 2005 (EP) 05 300 940.3

(51) Int. Cl. H04L 12/56; H04J 3/24

(52) U.S. Cl. 370/389; 370/349

(57) ABSTRACT

The present invention relates to a method for providing services from a server to a terminal over a mobile/wireless communication network. According to the present invention, the method comprises the steps of: sending messages from said server to an access node of said mobile/wireless communication network; extracting at said access node the payload from said message and storing it in a cache memory, including in the message a label identifying the location of said payload in said cache memory, forwarding said modified message to the terminal, downloading from the terminal said payload from said cache memory upon detection of appropriate radio conditions.

The invention is based on a priority application EP05300940.3 which is hereby incorporated by reference.

### TECHNICAL FIELD

The present invention relates to a method for providing services from a server to a terminal over a mobile/wireless communication network using cache technology.

### BACKGROUND OF THE INVENTION

Network using cache technology may be used in discontinuous coverage networks with zones of non coverage. The service continuity in such networks is guaranteed under the condition that the terminal has a large cache filled in advance with enough data in such a way that these data can be played seamlessly during the time when the terminal is not under coverage.

A consequence of this is that networks using cache technology may introduce long delays in the transmission. Standard protocols (transport and higher layers protocols) between terminal and server may not support these delays and this may have dramatic consequences as for example modifying the application behaviour (e.g. stopping on going communications), or making the network interface seen by the application as not available.

A solution for solving this problem consists in introducing a network proxy in the access node of the network using cache technology and terminating the communication protocols at the access node to simulate standard delivery to the network side.

This solution nevertheless presents the drawback that no more end to end IP connectivity can be provided since the IP transport and higher layers are terminated at the access node and no more in the terminal.

An additional drawback is that the complexity of the access node is considerably increased by this processing.

A particular object of the present invention is to provide a method for guarantying end to end IP connectivity also in networks using cache technology working with high transmission delays.

Another object of the invention is to provide a corresponding access node of such a network with cache technology and terminal.

### SUMMARY OF THE INVENTION

These objects, and others that appear below, are achieved by a method for providing services from a server to a terminal over a mobile/wireless communication network, said method comprising the steps of: sending messages from said server to an access node of said mobile/wireless communication network; extracting at said access node the payload from said message and storing it in a cache memory, including in the message a label identifying the location of said payload in said cache memory, forwarding said modified message to the terminal downloading from the terminal said payload from said cache memory upon detection of appropriate radio conditions. An access node of a mobile/wireless communication network comprising: means for receiving messages from a server and destined to a terminal, said messages comprising an header and a payload; means for extracting the payload from said message and storing it in a cache memory, means for including in the message a label identifying the location of said payload in said cache memory, means for forwarding said modified message to said terminal. And a terminal adapted to be provided services from a server over a mobile/wireless communication network comprising: means for receiving a modified message from an access node of said mobile/wireless communication network, said message not comprising the payload; means for detecting in the message a label identifying the location of said payload in a cache memory of said access node, means for downloading said payload from said cache memory upon detection of appropriate radio conditions.

According to the present invention, the payload is extracted from the message at the access node, stored in a memory and replaced by a label pointing on the memory location. The modified message is forwarded to the terminal using a legacy low speed connection. Independently of this the terminal downloads the payload using a high data rate connection when necessary.

The method according to the present invention presents the advantage to ensure end to end IP connectivity since the complete message header necessary for the connectivity is transmitted without delay to the terminal over a legacy low speed connection (e.g. GSM/GPRS or UMTS). The payload on the contrary can be freely downloaded from the memory location when the terminal cache status requires it and/or when a high speed connection is possible when the terminal is under the coverage of the non continuous coverage network. As a consequence the network side is not impacted by the cache mechanisms used on the other side of the air interface.

Another advantage of the present invention is that the access node of the network using cache technology is simplified since it does no more require any proxy functionality for terminating communication protocols.

Further advantageous features of the invention are defined in the dependent claims.

### BRIEF DESCRIPTION OF THE DRAWINGS

Other characteristics and advantages of the invention will appear on reading the following description of a preferred embodiment given by way of non-limiting illustrations, and from the accompanying drawings, in which:

FIG. 1 shows the communication between an access node and a terminal using the method of the present invention;

FIG. 2 shows a sequence of messages exchanged between an access node and a terminal for performing the method according to the present invention;

FIG. 3 shows a first method for retrieving cache information by the terminal in case of handover if the method according to the present invention is used;

FIG. 4 shows a second method for retrieving cache information by the terminal in case of handover if the method according to the present invention is used.

### DETAILED DESCRIPTION OF PREFERRED EMBODIMENTS

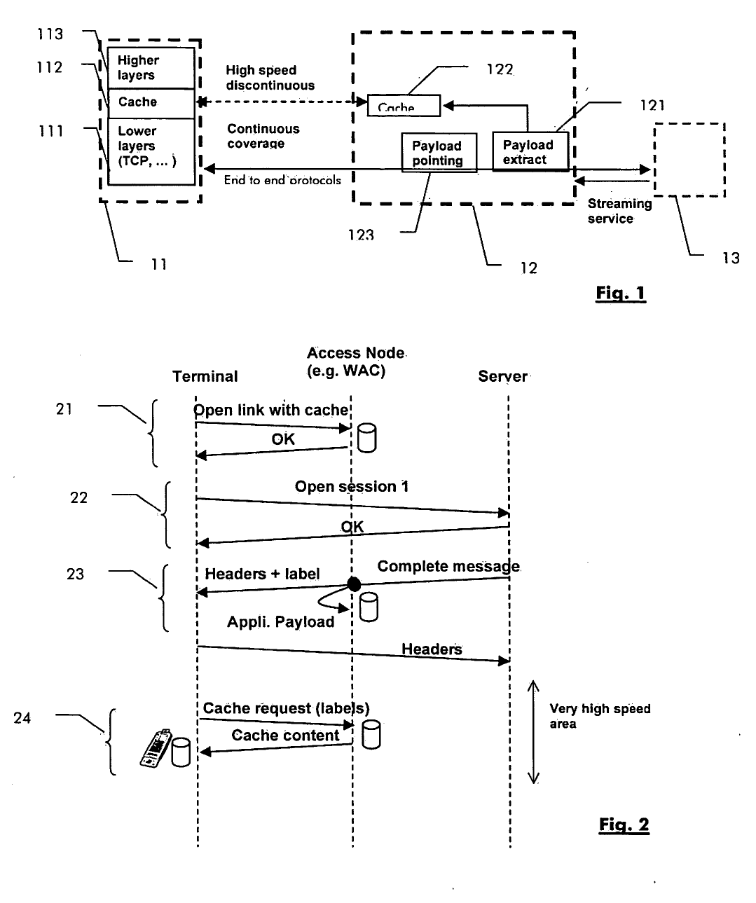

FIG. 1 shows the communication between an access node and a terminal using the method of the present invention. Terminal 11 comprises low layers 111, a cache layer 112 and higher layers 113 with an application layer. Access node 12 (e.g. a Wireless Access Controller WAC as defined by the WIMAX FORUM) comprises a payload extracting module 121, a cache 122, a payload pointing module 123. Server 13 is adapted to provide terminal 11 for example with streaming services supported by end to end protocols.

Both terminal 11 and access point 12 are supporting connections using a legacy radio communication network as GSM/GRPS/EDGE or UMTS with rather low bit rate connections. These connections enables terminal 11 to have a continuous radio coverage at low bit rate. On the other hand, both terminal 111 and access node 12 are adapted to establish high speed high data rate connections when terminal 11 is moving to specific island of coverage where such high speed connections are possible. Such island of coverage are usually not contiguous so that only discontinuous coverage is available for such high speed high data rate connections. Preferably, the use of such discontinuous coverage network with very high data rate is advantageous for applications like but not exclusively video streaming.

According to the present invention, and in order to guaranty end to end IP connectivity also in the framework of discontinuous coverage access networks, access node 12 extracts the payload from the received packets at payload extract module 121 and stores the payload in cache 122. Additionally, access node modifies the received packet in including in the packet an indication on the payload location so that terminal 11 can on purpose retrieve the payload stored at access node 12. Preferably the modified packet are forwarded to terminal 11 over the legacy radio communication network with low bit rate. This guaranties that the transmission delays which are controlled by the TCP/IP UDP/IP protocol suite are respected. The payload on this side remains at access node cache 122 until terminal 11 is able to establish a high speed data rate connection and can download with high bit rate the payload using the indication on the payload received in the modified packet.

FIG. 2 shows the sequence of messages exchanged between access node 12 and a terminal 11 for performing the method according to the present invention.

In a first step 21, terminal 11 opens a link with the access point cache in order to signal that it will use a service requiring cache functionality. The access node confirms then the availability of cache to terminal 11. This step is nevertheless not mandatory and other mechanisms can be envisaged for checking that cache is available at the access node.

In a second step 22, terminal 11 opens a session to a server 13. This session may request a streaming service or any other service requiring preferably a large bandwidth.

In a third step 23, upon downloading data from the server, the data belonging to the requested service, the access node extracts the data from the frames they are contained in and store them at the cache the terminal has established a link with. Then, the Access node further modifies the frame in adding a label consisting preferably in a pointer which points to the location of the cache the payload data extracted from the frame have been stored. Then the modified frame is sent from the access node to the terminal.

These first three steps 21, . . . , 23 can preferably be performed over an IP network for the portion between the server and the access node and over a legacy radio network (e.g. GSM-based or UMTS-based network for the portion between the access node and the terminal. Nevertheless, the type of networks are not restrictive the method according to the invention can also be implemented if other types of networks are available between the server and the access point and between the access point and the terminal.

Further steps 24 concern the retrieval of the payload data at the terminal and is preferably performed when the terminal enters a hot spot or a hot zone providing a large bandwidth and high downlink data rates (e.g.: a WIMAX hot zone or any other hot spot of a 4^{th} generation network).

In order to retrieve the payload the terminal send a cache request to the Access node using the labels it has stored from received modified frames. The access point use the labels as pointer to the cache allocated to the terminal and extract the stored payload data from the locations indicated by the labels. Then the payload data are encapsulated in frames and transferred to the terminal with high speed rate over the WIMAX or 4^{th} generation network.

According to the present invention it is also provided for appropriate methods for retrieving the cached data in case of handover performed at the terminal. Two preferred embodiments will be described in the following.

FIG. 3 shows a first method for retrieving cache information by the terminal in case of handover if the method according to the present invention is used. FIG. 3 shows a core part of a network comprising an home agent 31 according to Mobile IP terminology and an access part of the network comprising two access nodes 321, 322 and a terminal 33 which has left the coverage of access node 322 to enter the coverage of access node 321. Both access nodes comprise a cache having the functionality of storing payload data extracted from the received frames according to the method of the present invention. Upon hand over detection at home agent 31, sends home agent 31 a trigger to access node 322 to send the content of its cache related to terminal 33 to access node 321. Then, all payload data destined to the terminal are located in the access node the mobile terminal has been handed over to (serving access node). When good radio conditions are met, the terminal 33 requires the payload data from the serving access node 321 to which it is attached. More precisely terminal 33 comprises means for receiving a modified message from access node 321, the message not comprising a payload. Terminal 33 further comprises means for detecting in the message a label identifying the location of the missing payload in a cache memory of access node 321, as well as means for downloading the payload from the identified location of the cache memory upon detection of appropriate radio conditions.

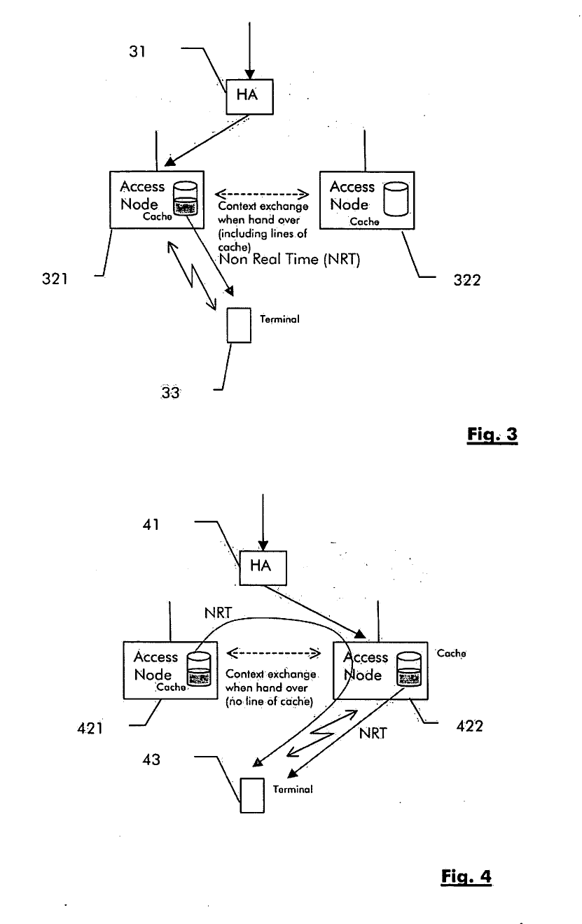

FIG. 4 shows a second method for retrieving cache information by the terminal in case of handover if the method according to the present invention is used. FIG. 4 shows a network part comprising a home agent 41 according to the mobile IP protocol terminology, two access nodes 421, 422 and a terminal 43 which has left the coverage of access node 421 to enter the coverage of access node 422. Both access nodes 421, 422 comprise a cache having the functionality of storing payload data extracted from the received frames according to the method of the present invention. Payload data are created and stored in the Access Node cache memory, and stay in this location all the time during the terminal movement. After many “hand over”, payload data may be distributed in many Access Nodes 421, 422 for the some terminal 43.

When good radio conditions are met, the terminal 43 retrieves the required line of cache in the right location access node 421 cache or access node 422 cache, with the help of the “Access Node address” which was received from the serving access node 422 in the label of the “end to end” corresponding message. This information is part of the context transferred from access node 421 to access node 422 when handover is performed. In this embodiment of the present invention only the context is transferred from access node 421 to access node 422 at handover but not the lines of caches which remain in the cache of access node 421.

More precisely, terminal 43 comprises means for receiving a modified message from access node 422, the message not comprising a payload. Terminal 43 further comprises means for detecting in the message a label identifying the locations of the missing payload in a cache memory of access node 421 and of access node 422, as well as means for downloading the payload from the identified locations of the cache memory upon detection of appropriate radio conditions.

The advantage of this embodiment consists in avoiding the transfer of payload data between different access nodes upon hand over of the terminal. This reduce the handover duration.

1/ A method for providing services from a server to a terminal over a mobile/wireless communication network, said method comprising the steps of:
sending messages from said server to an access node of said mobile/wireless communication network;
extracting at said access node the payload from said message and storing it in a cache memory,
including in the message a label identifying the location of said payload in said cache memory,
forwarding said modified message to the terminal
downloading from the terminal said payload from said cache memory upon detection of appropriate radio conditions.

2/ The method according to claim 1, wherein said the modified message is transmitted from said access point to said terminal over a low speed legacy mobile communication network.

3/ The method according to claim 1, wherein said terminal establishes a high speed high data rate communication with said access node to retrieve said payload preferably using WIMAX, WIFI standards when said terminal is under the coverage of said mobile/wireless communication network.

4/ The method according to claim 1, wherein upon handover of said terminal between several access points said payload is retrieved from cache memory at said several access points.

5/ The method according to claim 1, wherein upon handover of said terminal between several access points, said payload is transferred from said several access points to the serving access point at the time when said payload is requested from said terminal.

6/ The method according to claim 1, wherein said services are streaming services.

7/ An access node of a mobile/wireless communication network comprising:
means for receiving messages from a server and destined to a terminal, said messages comprising an header and a payload;
means for extracting the payload from said message and storing it in a cache memory,
means for including in the message a label identifying the location of said payload in said cache memory,
means for forwarding said modified message to said terminal.

8/ A terminal adopted to be provided services from a server over a mobile/wireless communication network comprising:
means for receiving a modified message from an access node of said mobile/wireless communication network, said message not comprising the payload;
means for detecting in the message a label identifying the location of said payload in a cache memory of said access node,
means for downloading said payload from said cache memory upon detection of appropriate radio conditions.
